(19) United States
(12) Patent Application Publication
(10) Pub. No.: US 2024/0188778 A1
(43) Pub. Date: Jun. 13, 2024

(54) DUST COLLECTING ATTACHMENT FOR BLOWER

(71) Applicant: MAKITA CORPORATION, Anjo-shi (JP)

(72) Inventor: Takumi HAYASHI, Anjo-shi (JP)

(73) Assignee: MAKITA CORPORATION, Anjo-shi (JP)

(21) Appl. No.: 18/514,474

(22) Filed: Nov. 20, 2023

(30) Foreign Application Priority Data
Dec. 12, 2022 (JP) 2022-197930

(51) Int. Cl. A47L 9/14; A47L 9/12; A47L 9/24; F04D 25/06; F04D 29/70

(52) U.S. Cl. CPC A47L 9/1454; A47L 9/12; A47L 9/24; F04D 25/06; F04D 29/701

(57) ABSTRACT

A dust collecting attachment is configured to be removably attached to a blower. The blower includes a housing that has an inlet opening and a discharge opening, a motor that is within the housing, and a fan that is within the housing and is configured to be rotated by the motor to generate a flow of air that is sucked into the housing through the inlet opening and is discharged from the discharge opening via the motor. The dust collecting attachment includes an attachment body that has a first opening, a second opening, and a dust storage space between the first opening and the second opening. The attachment body is configured to be attached to the housing such that the second opening communicates with the inlet opening of the housing of the blower.

### CROSS-REFERENCE TO RELATED APPLICATION

The present application claims priority to Japanese patent application No. 2022-197930 filed on Dec. 12, 2022, the contents of which are hereby fully incorporated herein by reference.

### TECHNICAL FIELD

The present disclosure relates to a dust collecting attachment that is configured to be removably attached to a blower.

### BACKGROUND

Some known electric blowers are configured to blow off grit, dust, etc. by discharging air through a discharging opening. For example, Japanese Unexamined Patent Application Publication No. 2011-117442 discloses a blower (a so-called air duster) that is configured to suck air through an inlet opening, compress the air and discharge compressed air through a nozzle, using a plurality of centrifugal fans rotated by a motor. This blower can be also utilized as a dust collecting cleaner when a suction nozzle is attached to the inlet opening.

### SUMMARY

When dust is collected by the above-described blower to which the suction nozzle is attached, dust is sucked through the suction nozzle and enters into a blower body. The dust that has entered the blower body may adversely affect the motor. Thus, there is still room for improvement in the blower and the suction nozzle.

Accordingly, one, non-limiting object of the present disclosure is to provide an improved attachment that is configured to be attached to a blower to be used for dust collection.

A non-limiting aspect of the present disclosure herein provides a dust collecting attachment that is configured to be removably attached to a blower. The blower includes a housing, a motor, and a fan. The housing has an inlet opening and a discharge opening. The motor and the fan are within the housing. The fan is configured to be rotated by the motor to generate a flow of air that is sucked into the housing through the inlet opening and is discharged from the discharge opening via the motor. The dust collecting attachment includes an attachment body. The attachment body has a first opening, a second opening, and a dust storage space between the first opening and the second opening. The attachment body is configured to be attached to the housing such that the second opening communicates with the inlet opening of the housing of the blower.

The dust collecting attachment of this aspect is used in a state in which the dust collecting attachment is attached to the housing such that the second opening communicates with the inlet opening of the housing of the blower. When the fan is rotated by the motor of the blower, air flows into the dust collecting attachment through the first opening, passes the dust storage space, and is discharged through the second opening to be sucked into the housing through the inlet opening of the blower. On the other hand, foreign matters (e.g., dust, grit, etc.) that are contained in the air are stored in the dust storage space between the first opening and the second opening within the dust collecting attachment. Thus, a possibility can be reduced that the foreign matters enter the blower and adversely affect the motor.

Another non-limiting aspect of the present disclosure provides a dust collecting system that includes a blower and a dust collecting attachment. The blower includes a housing, a motor, and a fan. The housing has an inlet opening and a discharge opening. The motor is within the housing. The fan within the housing and is configured to be rotated by the motor to generate a flow of air that is sucked into the housing through the inlet opening and is discharged from the discharge opening via the motor. The dust collecting attachment may be the dust collecting attachment according to the above-described aspect. The attachment body of the dust collecting attachment is removably attached to the housing of the blower such that the second opening of the attachment body communicates with the inlet opening of the housing of the blower.

According to the dust collecting system of this aspect, when the fan is rotated by the motor of the blower, foreign matters (e.g., dust, grit, etc.) are stored in the dust storage space within the dust collecting attachment, which is removably attached to the housing, before the air is sucked into the inlet opening of the housing. Thus, a possibility can be reduced that the foreign matters enter the blower and adversely affect the motor.

### BRIEF DESCRIPTION OF THE DRAWINGS

FIG. 1 is a perspective view of a dust collecting system.

FIG. 2 is a sectional view of a blower.

FIG. 3 is a partial, perspective view of the blower from which an inlet-side cover is removed.

FIG. 4 is an overall view of a dust collecting attachment.

FIG. 5 is a sectional view taken along line V-V in FIG. 4.

FIG. 6 is a sectional view of the dust collecting system wherein only an attachment body is shown in the dust collecting attachment.

FIG. 7 is a partial, sectional view taken along line VII-VII in FIG. 6.

FIG. 8 is a perspective view of the attachment body.

FIG. 9 is an exploded perspective view of the attachment body.

### DETAILED DESCRIPTION OF THE EMBODIMENTS

In one non-limiting embodiment according to the present disclosure, the dust collecting attachment may further include a first filter that is housed within the attachment body between the dust storage space and the second opening. According to this embodiment, since the foreign matters can be captured by the filter and retained in the dust storage space, a possibility can be further reduced that the foreign mattes enter the housing of the blower.

In addition or in the alternative to the preceding embodiment, the first filter may be removable from the attachment body. According to this embodiment, a user can easily clean the first filter after removing the first filter from the attachment body. Further, the user can remove the first filter from the attachment body to replace the first filter with a new one. Thus, deterioration of the air-blowing efficiency due to clogging of the first filter can be suppressed.

In addition or in the alternative to the preceding embodiments, the first filter may be fixed to the attachment body. According to this embodiment, the user can remove the attachment body from the housing of the blower and then clean the first filter. Thus, deterioration of the air-blowing efficiency due to clogging of the first filter can be suppressed.

In addition or in the alternative to the preceding embodiments, the attachment body may include a check valve between the first opening and the dust storage space. According to this embodiment, the check valve can prevent the foreign matters retained in the dust storage space from leaking out of the attachment body through the first opening.

In addition or in the alternative to the preceding embodiments, the attachment body may have an opening that communicates with the dust storage space and an outside, and a lid that is configured to open and close the opening. According to this embodiment, the user can open the lid and easily remove the foreign matters retained in the dust storage space from the attachment body without removing the attachment body from the blower.

In addition or in the alternative to the preceding embodiments, the dust collecting attachment may further include an elongate tubular member that is coupled to the first opening of the attachment body. At least a portion of the tubular member may be flexible. The tubular member may be configured as, for example, a hose at least partially having a bellows structure. According to this embodiment, the user can relatively freely change the position of the distal end of the tubular member regardless of the orientations of the blower and the attachment body. Thus, the dust collecting attachment having superior operability (maneuverability) can be achieved.

In addition or in the alternative to the preceding embodiments, the first filter may face the inlet opening of the housing of the blower. According to this embodiment, the air that has passed the first filter can effectively flow into the housing of the blower.

In addition or in the alternative to the preceding embodiments, the blower may further include a second filter between the inlet opening and the motor. The first filter of the dust collecting attachment may have a mesh size that is smaller than a mech size of the second filter of the blower. According to this embodiment, the air-blowing efficiency and the capturing performance of the foreign matters can be appropriately balanced, depending on whether the blower is used alone or the blower is used as a dust collector with the dust collecting attachment attached thereto.

In addition or in the alternative to the preceding embodiments, the attachment body may include a tubular part that has the first opening at its distal end. The tubular part may be configured to extend in a direction that crosses a rotational axis of the motor when the attachment body is attached to the housing of the blower. The housing of the blower and the attachment body may be configured such that a position of the tubular part is changeable in a circumferential direction around the rotational axis of the motor. According to this embodiment, the user can change the orientation of the attachment body (the arrangement of the tubular part) depending on a working environment, so that the operability can be enhanced.

A dust collecting system 9 according to a representative, non-limiting embodiment of the present disclosure is now specifically described with reference to the drawings.

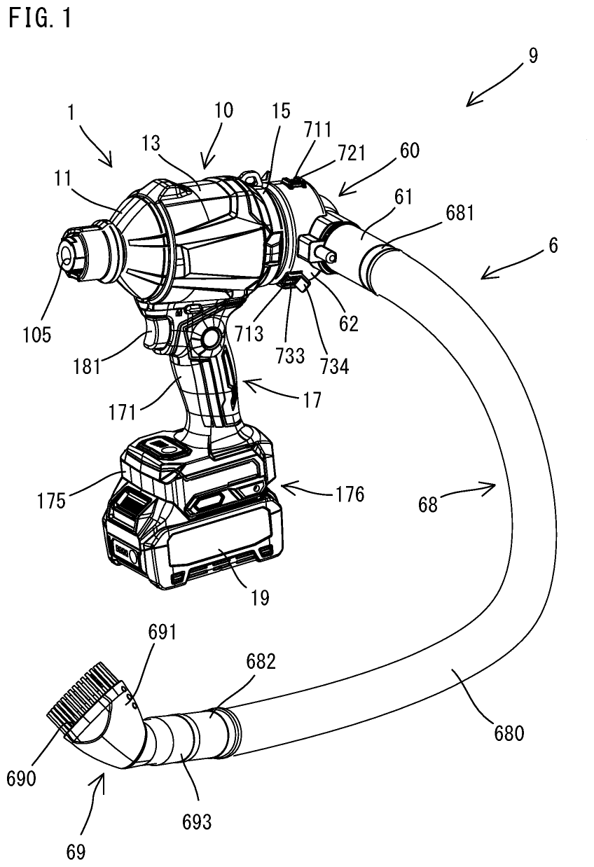

First, the general structure of the dust collecting system 9 is described. As shown in FIG. 1, the dust collecting system 9 includes a blower 1, and a dust collecting attachment 6 that is removably attached (mounted, coupled) to the blower 1. The blower 1 is an electric blower that can be used separately (independently) from the dust collecting attachment 6. Specifically, the blower 1 is configured to discharge compressed air through a discharge opening 105 to blow off dust, grit, etc. The dust collecting attachment 6 is configured to be selectively attached to the blower 1 to be used to collect dust, grit etc. When the dust collecting attachment 6 is attached to the blower 1, the blower 1 and the dust collecting attachment 6 together serve as a dust collector. Thus, the blower 1 and the dust collecting attachment 6 together form the dust collecting system 9.

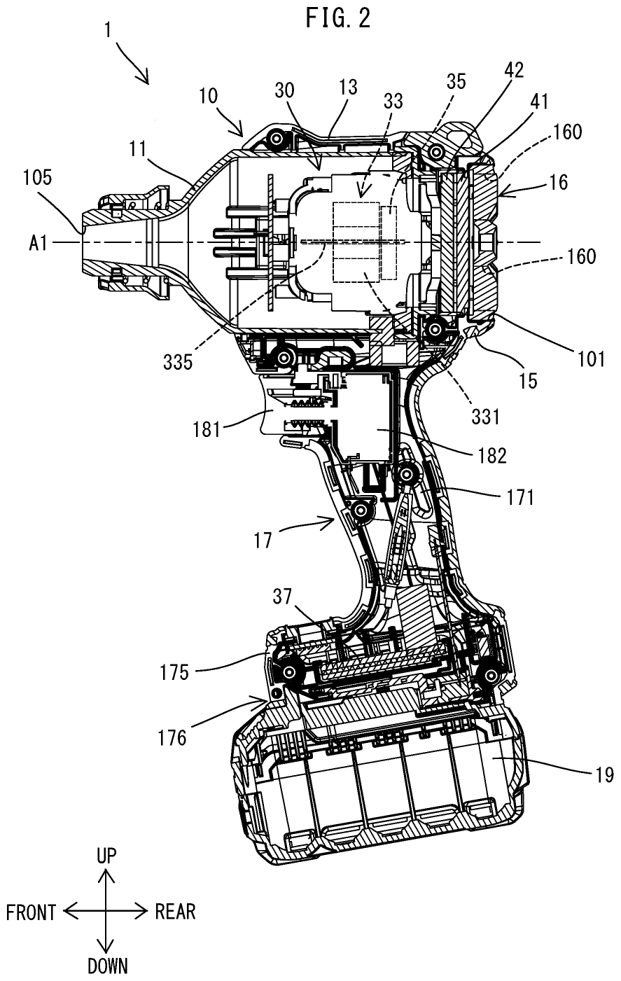

As shown in FIGS. 1 and 2, the blower 1 includes a body housing 10, a motor 33 and a fan 35. The motor 33 and the fan 35 are housed within the body housing 10. A handle 17 that is configured to be gripped (held) by a user is coupled to the body housing 10.

In this embodiment, an inlet opening 101, through which air is sucked into the body housing 10, is formed at one end of the body housing 10 in an extension direction of a rotational axis A1 of a motor shaft 335 (hereinafter also simply referred to as a rotational-axis-A1 direction) of the motor 33. A discharge opening 105, through which the compressed air is discharged, is formed at the other end of the body housing 10 in the rotational-axis-A1 direction.

The handle 17 extends from the body housing 10 in a direction that crosses the rotational axis A1. A trigger 181, which is configured to be manually depressed (pulled) by the user, is disposed at a base end portion (an end portion coupled to the body housing 10) of the handle 17. Further, a battery 19, which is a power source of the blower 1, is removably mounted a protruding end portion (a distal end portion) of the handle 17.

When the blower 1 is used as an air duster (a dust blower) that discharges the compressed air from the discharge opening 105 toward an object, an inlet-side cover 16 is attached to the inlet opening 101, as shown in FIG. 2. The inlet-side cover 16 has a plurality of openings 160. When the trigger 181 is depressed by the user and thereby the motor 33 is energized and the fan 35 is rotationally driven, air is sucked into the body housing 10 through the inlet opening 101 (the openings 160 of the inlet-side cover 16) and the air compressed by the fan 35 is discharged through the discharge opening 105.

When the blower 1 is used as a dust collector that sucks and collects foreign matters such as dust (hereinafter, simply referred to as dust), the dust collecting attachment 6 is attached to the inlet opening 101, as shown in FIG. 1. The dust collecting attachment 6 includes (i) an attachment body 60 that is configured to be removably attached (mounted, coupled) to the body housing 10 of the blower 1. (ii) a hose 68 that is coupled to the attachment body 60, and (iii) a suction nozzle 69 that is coupled to a distal end of the hose 68. When the fan 35 is rotated, air that contains dust is sucked through the suction nozzle 69 and passes through the hose 68 to reach the attachment body 60. The dust is separated from the air and stored in the attachment body 60, and only the air is sucked through the inlet opening 101 of the blower 1 into the body housing 10 and then compressed and discharged through the discharge opening 105.

The detailed structure of the blower 1 is now described. In the following description, for the sake of convenience, the rotational-axis-A1 direction is defined as a front-rear direction of the blower 1. In the front-rear direction, a direction from the inlet opening 101 toward the discharge opening 105 is defined as a forward direction, and an opposite direction thereof (a direction from the discharge opening 105 toward the inlet opening 101) is defined as a rearward direction. A direction that is orthogonal to the rotational-axis-A1 direction and that generally corresponds to the extension direction of the handle 17 is defined as an up-down direction of the blower 1. In the up-down direction, a direction in which the handle 17 protrudes from the body housing 10 (a direction from the body housing 10 toward the protruding end of the handle 17) is defined as a downward direction, and an opposite direction thereof (a direction from the protruding end of the handle 17 toward the body housing 10) is defined as an upward direction. A direction that is orthogonal to both of the front-rear direction and the up-down direction is defined as a left-right direction of the blower 1.

First, the body housing 10 and elements (structures) disposed within the body housing 10 are described.

As shown in FIG. 2, a front end portion of the body housing 10 has a funnel shape as a whole and is also called a nozzle part 11. An opening at the front end of the nozzle part 11 serves as the discharge opening 105 that allows the compressed air to flow out from the body housing 10. Although not described or shown in detail, the nozzle part 11 is configured such that nozzles that are separately prepared for various usages can be selectively attached thereto. A remaining portion of the body housing 10 other than the nozzle part 11 has a generally cylindrical shape. This portion is a housing part 13 that houses the motor 33 and the fan 35. An opening at the rear end of the housing part 13 serves as the inlet opening 101 that allows the air to flow into the body housing 10. A rear end portion 15 of the housing part 13 (the body housing 10) is configured such that the inlet-side cover 16 and the dust collecting attachment 6 can be selectively attached (mounted, coupled) thereto.

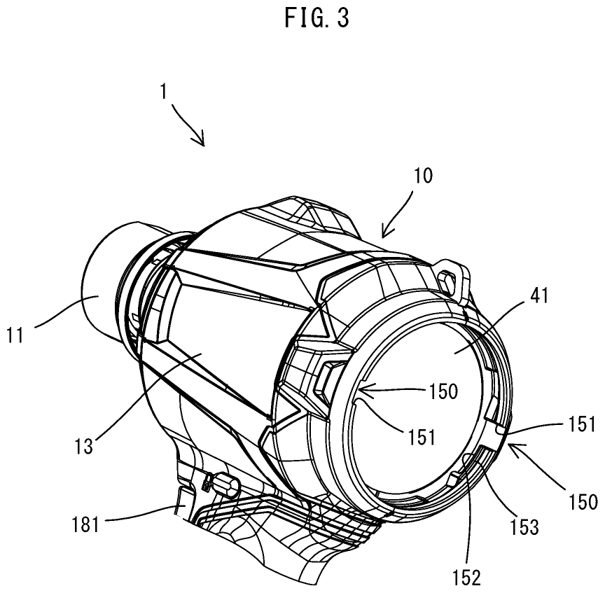

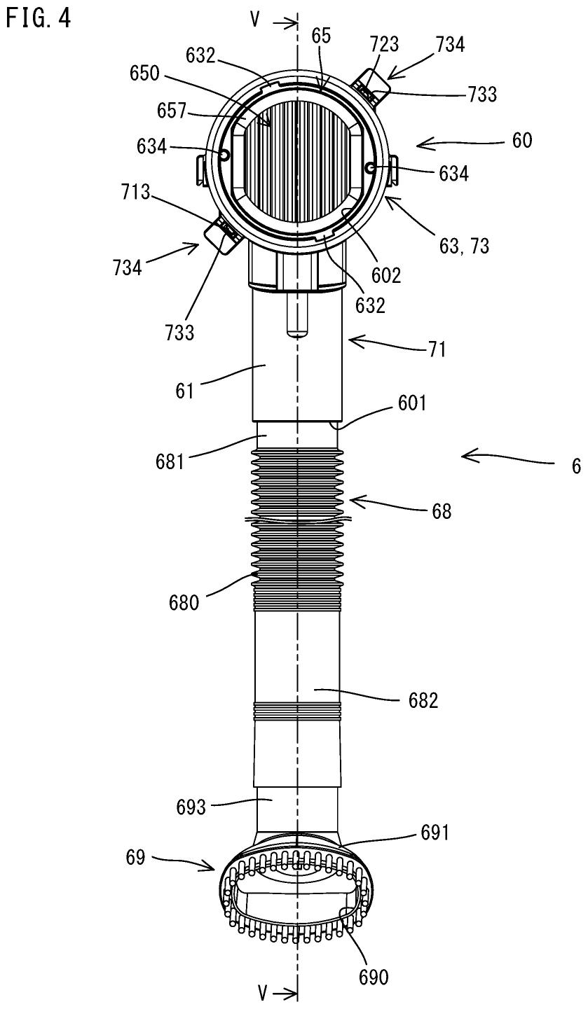

More specifically, as shown in FIG. 3, the rear end portion 15 has a generally cylindrical shape. Two engagement grooves 150 are formed on an inner peripheral surface of the rear end portion 15. The two engagement grooves 150 are disposed at a left rear end and a right rear end of the rear end portion 15, respectively, to be in symmetry relative to the center axis of the rear end portion 15. The two engagement grooves 150 are thus diametrically opposite to each other (or face each other in the diametrical direction of the rear end portion 15). Each of the engagement grooves 150 is an L-shaped groove that includes a first portion 151 and a second portion 152. The first portion 151 extends frontward from the rear end of the rear end portion 15. The second portion 152 extends in a circumferential direction around the center axis of the rear end portion 15 from the front end of the first portion 151. Thus, a wall portion 153 is formed at the rear side of the second portion 152. When protrusions (not shown) of the inlet-side cover 16 or engagement protrusions 632 (see FIG. 4) of the dust collecting attachment 6 respectively engage with the engagement grooves 150, the inlet-side cover 16 or the dust collecting attachment 6 is attached to the body housing 10, as will be described in detail later.

As shown in FIG. 2, the motor 33 and the fan 35 are disposed between the inlet opening 101 and the discharge opening 105 in the front-rear direction. The motor 33 of this embodiment is a brushless DC motor. The fan 35 is a centrifugal fan and is fixed to the motor shaft 335 at the rear side of the stator 331 of the motor 33. The fan 35 rotates integrally with the motor shaft 335 around the rotational axis A1 so as to generate a flow of air that is sucked through the inlet opening 101 into the body housing 10, passes through the motor 33 and is discharged through the discharge opening 105. Although not described or shown in detail, in this embodiment, the motor 33 and the fan 35 are housed in a case to form a motor assembly 30.

Two filters 41 and 42 are disposed in the rear end portion 15 (rearward of or behind the fan 35) of the housing part 13. The filter 41 is rearward of the filter 42 (between the filter 42 and the inlet opening 101). The rear filter 41 is fitted into the rear end portion 15 such that the filter 41 is easily removable from the rear end portion 15. The front filter 42 is held to be substantially irremovable from rear end portion 15.

In this embodiment, the filters 41 and 42 have different mesh sizes. More specifically, the rear filter 41 has a mesh size that is smaller than that of the front filter 42 (i.e., the rear filter 41 captures (catches) finer dust (e.g., particles having smaller diameters)). By employing a filter having superior capturing performance of foreign matters as the filter 41, which is easily removable for its cleaning or replacement when the filter 41 is clogged, a rational structure for capturing the foreign matters in two stages can be achieved. The filters 41 and 42 capture the dust that has entered the body housing 10 together with the air from the inlet opening 101 so as to reduce the possibility that the dust adversely affects the motor 33.

In this embodiment, a filter that is formed by a synthetic resin (polymeric) open-cell foam (specifically, a polyurethane sponge) is employed as each of the filters 41 and 42. However, any other types of filter (for example, a HEPA filter, (High Efficiency Particulate Air Filter), a powder filter, and a non-woven fabric filter) may be employed.

The handle 17 and elements (structures) disposed within the handle 17 are now described.

As shown in FIGS. 1 and 2, the handle 17 includes a tubular grip part 171 that extends generally in the up-down direction, and a box-like controller-housing part 175 that is connected to a lower end of the grip part 171.

The grip part 171 is a portion to be gripped by the user. The trigger 181 is provided at an upper front end portion of the grip part 171. A switch 182 is housed within the grip part 171. The switch 182 is normally kept OFF. When the trigger 181 is manually depressed, the switch 182 is turned ON. The switch 182 is electrically connected to a controller 37 via wires (not shown).

The controller-housing part 175 houses the controller 37. The controller 37 is configured to control the driving of the motor 33 in response to a signal that is output from the switch 182. A battery mounting part 176, which is configured to removably receive the rechargeable battery (also referred to as a battery pack) 19, is provided in (at) a lower end portion of the controller-housing part 175. The structures of the battery mounting part 176 and the battery 19 themselves are well known and therefore not described here. The power source of the blower 1 may be a disposable battery or an external AC power source, instead of the battery 19. Further, a rechargeable battery may be incorporated in the blower 1.

The detailed structure of the dust collecting attachment 6 is now described.

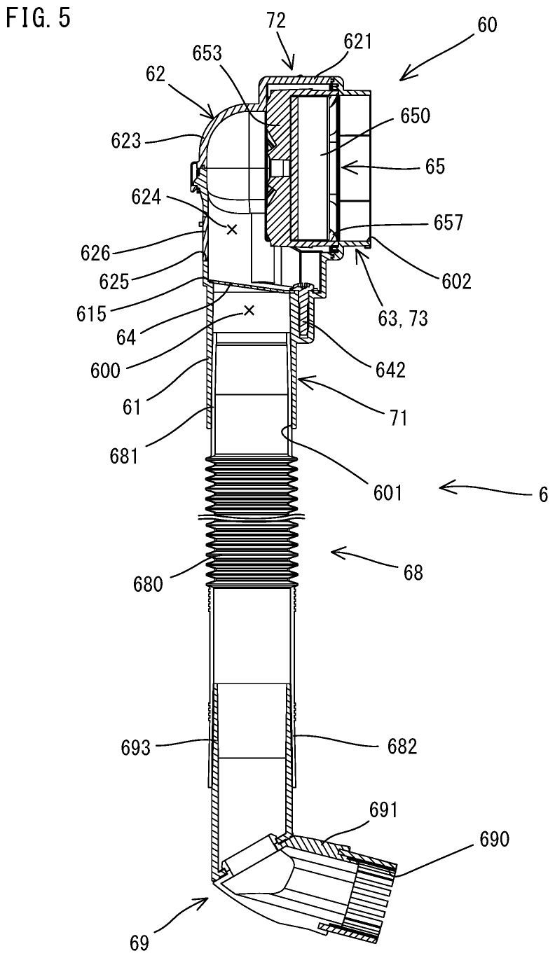

As shown in FIGS. 4 and 5, the dust collecting attachment 6 includes an attachment body 60, a filter 650, a hose 68, and a suction nozzle 69.

First, the attachment body 60 is described. The attachment body 60 is configured to be coupled (attached, mounted) to the body housing 10 of the blower 1. The attachment body 60 of this embodiment is a hollow body having a first opening 601 and a second opening 602.

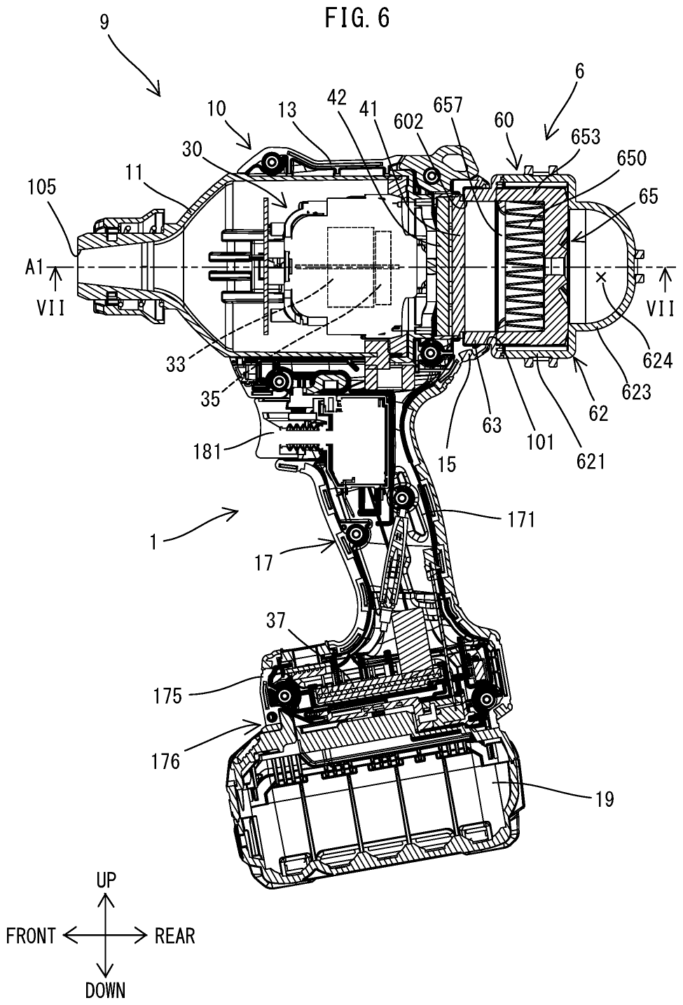

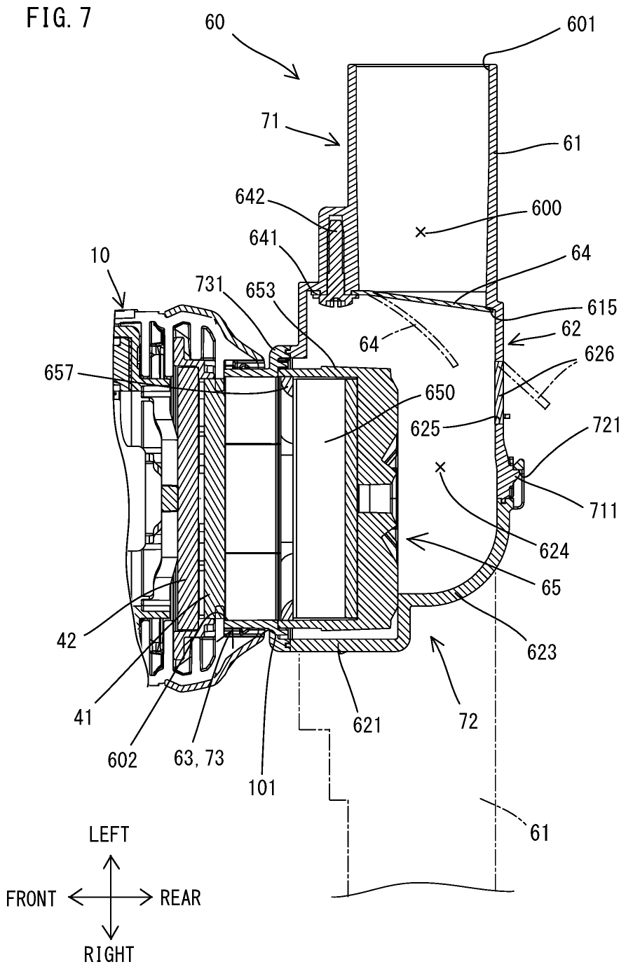

More specifically, as shown in FIGS. 6 to 8, the attachment body 60 includes (i) a tubular inlet part 61 that has the first opening 601 at its one end, (ii) a hollow housing part 62 that is connected to the other end of the inlet part 61, (iii) and a tubular exhaust part 63 that extends from the housing part 62 in a direction that crosses (intersects) an extension direction of the inlet part 61 (specifically, in a direction that is generally orthogonal to the extension direction) and has the second opening 602 at its distal end. Owing to such a structure, the attachment body 60 defines a generally L-shaped air passage 600 (see FIG. 7). The first opening 601 of the inlet part 61 serves as an inlet opening of the attachment body 60 that allows air to flow into the attachment body 60 when the attachment body 60 is attached to the blower 1 for use with the blower 1. The second opening 602 of the exhaust part 63 serves as an exhaust opening of the attachment body 60 that allows the air to be discharged to an outside of the attachment body 60 (and into the body housing 10 of the blower 1) when the attachment body 60 is attached to the blower 1 for use with the blower 1.

The inlet part 61 has a substantially cylindrical shape. The inlet part 61 defines an inlet passage that extends from the first opening 601, and communicates with the housing part 62. The inlet part 61 is configured as a coupling part to which the hose 68 can be coupled. The hose 68 is removably inserted into the inlet part 61 through the first opening 601.

A portion of the housing part 62 that is adjacent to the exhaust part 63 has a hollow cylindrical shape and has a center axis that extends in a direction that crosses the extension direction of the inlet part 61 (specifically, in the direction that is generally orthogonal to the extension direction). This cylindrical portion houses the filter 650 (a filter unit 65). Hereinafter, the cylindrical portion of the housing part 62 that houses the filter 650 is referred to as a filter housing part 621. A remaining portion of the housing part 62 other than the filter housing part 621 (i.e., a portion between the inlet part 61 and the filter housing part 621 in a flow direction of the air, which is hereinafter referred to as a airflow direction) serves as a dust storage part 623. The dust storage part 623 defines a dust storage space 624 in which the dust is stored (accommodated).

As shown in FIG. 7, a check valve (a one-way valve) 64 is disposed between the first opening 601 (the inlet opening) and the dust storage space 624. The check valve 64 is configured to block the dust in the dust storage space 624 from moving toward the first opening 601. In this embodiment, the check valve 64 is configured to close the passage 600 in the attachment body 60 at a downstream end of the inlet part 61 (a boundary between the inlet part 61 and the housing part 62) in the airflow direction.

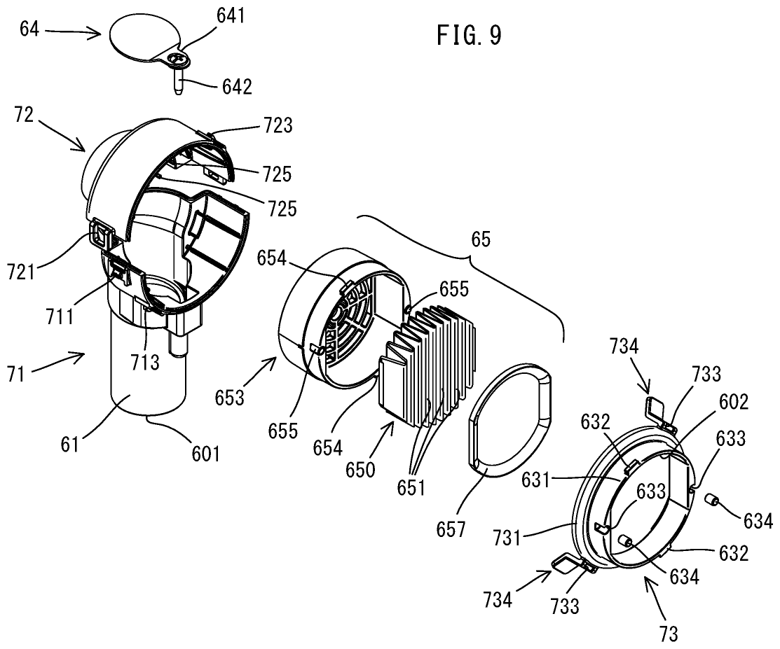

The check valve 64 of this embodiment is a flap gate check valve. More specifically, the check valve 64 is formed from a flexible sheet (for example, rubber or flexible polymer sheet). The check valve 64 has a generally circular shape that corresponds to the sectional shape of a downstream end portion of the inlet part 61 (see FIG. 9). The check valve 64 has a protrusion 641 that protrudes radially outward from a portion in the circumferential direction of the check valve 64. The check valve 64 is fixed to the downstream end portion of the inlet part 61 via a screw 642. As shown by a solid line in FIG. 7, the check valve 64 is configured to substantially close the passage 600 when the blower 1 is not operating. On the other hand, when the motor 33 is driven and the fan 35 generates the flow of air that flows into the body housing 10 through the inlet opening 101, as shown by a dashed line in FIG. 7, a portion of the check valve 64 that is spaced apart from the protrusion 641 is pulled toward the blower 1, so that the passage 600 is opened.

When the air flows in a reverse direction for some reason or when the first opening 601 is directed toward the ground, a force toward the first opening 601 may be applied to the check valve 64. However, an outer edge portion of the circular check valve 64 other than the protrusion 641 comes into contact with a shoulder part 615 (a stepped portion), which is formed between the inlet part 61 and the housing part 62, so that the passage 600 is kept to be closed. Thus, the check valve 64 can effectively prevent the dust stored in the dust storage space 624 from leaking out of the attachment body 60 through the first opening 601. The check valve 64 may be a linearly movable check valve, instead of the above-described flap gate check valve.

Further, as shown in FIG. 7, the dust storage part 623 has an opening 625 that communicates with the dust storage space 624 and the outside of the dust storage part 623, and a lid (cover) 626 that is configured to open and close the opening 625. The lid 626 is supported by the housing part 62 to be pivotable between (i) a close position (a position shown by a solid line), at which the lid 626 closes the opening 625, and (ii) an open position (a position shown by a dashed line), at which the lid 626 opens the opening 625. The lid 626 may be linearly slidable between an open position and a close position, instead of being pivotable as described above.

As shown in FIGS. 6 to 8, the exhaust part 63 has a substantially cylindrical shape. The exhaust part 63 defines an exhaust passage that extends from the housing part 62 to the second opening 602. The exhaust part 63 is configured to be removably attached (mounted, coupled) to the body housing 10 of the blower 1. Thus, the exhaust part 63 is configured as a coupling part (a mount part) that is removably coupled to the blower 1.

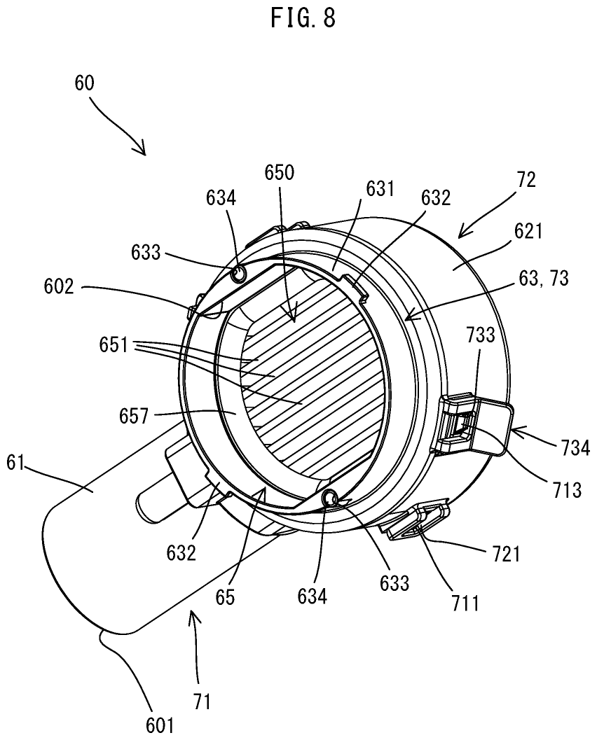

More specifically, as shown in FIG. 8, two engagement protrusions 632 protrude radially outward from an outer peripheral surface of an end portion 631 of the exhaust part 63 that has the second opening 602 (the exhaust opening). The two engagement protrusions 632 are in symmetry relative to the center axis of the exhaust part 63. In other words, the two engagement protrusions 632 are diametrically opposite to each other (or face each other in the diametrical direction of the exhaust part 63). The engagement protrusions 632 are configured to engage with the respective engagement grooves 150 (see FIG. 3) of the body housing 10 of the blower 1. Further, two recesses 633 are formed in the outer peripheral surface of the end portion 631. A cylindrical elastic pin 634 is fitted into each of the recesses 633 and held in place. In this embodiment, the elastic pin 634 is made of rubber (i.e., the elastic pin 634 is a rubber pin). However, the elastic pin 634 may be made of a different kind of elastic material (for example, synthetic resin or polymeric material).

When a user attaches the attachment body 60 to the body housing 10 of the blower 1, the user moves the attachment body 60 frontward relative to the rear end portion 15 such that the engagement protrusions 632 of the exhaust part 63 enter the respective first portions 151 of the engagement grooves 150 from behind. Thereafter, the user turns the attachment body 60 such that the engagement protrusions 632 move in the circumferential direction within the respective second portions 152. Accordingly, a portion of each of the engagement protrusions 632 is positioned in front of the wall portion 153. The wall portion 153 abuts a portion of the engagement protrusion 632 from the rear side so as to prevent the attachment body 60 from moving rearward. The elastic pins 634 are held in contact with the inner peripheral surface of the rear end portion 15 and cause frictional resistance, so as to restrict rotation of the attachment body 60 relative to the body housing 10. Thus, the elastic pins 634 can reduce the possibility that the attachment body 60 drops off from the rear end portion 15. The user can easily remove the attachment body 60 from the body housing 10 of the blower 1 by moving the attachment body 60 relative to the rear end portion 15 in a direction opposite to that in its attaching operation.

Although not shown in detail, the inlet-side cover 16 (see FIG. 2) that is attached when the blower 1 is used as the air duster has two engagement protrusions having the same configurations as the two engagement protrusions 632 of the attachment body 60.

As described above, in this embodiment, the two engagement grooves 150 of the body housing 10 of the blower 1 face each other in the diametrical direction of the cylindrical rear end portion 15 (see FIG. 3). In addition, the two engagement protrusions 632 of the attachment body 60 face each other in the diametrical direction of the cylindrical exhaust part 63. Thus, as shown in FIG. 7, the attachment position of the attachment body 60 relative to the body housing 10 of the blower 1 is switchable between (i) a first position (a position shown by a solid line) and a (ii) second position (a position shown by a dashed line) that is turned by 180 degrees from the first position. When the attachment body 60 is attached to the body housing 10 in the first portion, the inlet part 61 is positioned such that the inlet part 61 protrudes leftward relative to the rotational axis A1 of the motor 33. Thus, the hose 68 extends from the left side of the blower 1. On the other hand, when the attachment body 60 is attached to the body housing 10 in the second position, the inlet part 61 is positioned such that the inlet part 61 protrudes rightward relative to the rotational axis A1. Thus, the hose 68 extends from the right side of the blower 1.

As shown in FIG. 9, the attachment body 60 of this embodiment is formed by plurality of components (parts) that are coupled to each other. Specifically, the attachment body 60 is formed by (i) a first component 71 that forms the inlet part 61 and a portion of the housing part 62, (ii) a second component 72 that forms another portion of the housing part 62, and (iii) a third component 73 that forms the exhaust part 63. Each of the first component 71, the second component 72, and the third component 73 is made of synthetic resin (polymeric material).

The first component 71 and the second component 72 are coupled to each other via a snap-fit between protrusions 711 on the first component 71 and recesses 721 on the second component 72. The first component 71 and the second component 72 are coupled and integrated together to form the inlet part 61 and the housing part 62. Similarly, the first component 71 and the third component 73 are coupled to each other via a snap-fit between protrusions 713 on the first component 71 and recesses 733 on the third component 73. The second component 72 and the third component 73 are coupled to each other via a snap-fit between protrusions 723 on the second component 72 and recesses 733 on the third component 73.

In this embodiment, each of the recesses 733 of the third component 73 is formed on a flexible piece 734 having a tab. Therefore, when replacing the filter 650, the user can easily manipulate the tabs to release the third component 73 from the first component 71 and the second component 72 that are integrated together. In this manner, the third component 73, or the exhaust part 63, serves as a lid (a cover) that is removable from the housing part 62 that houses the filter 650.

The filter 650 is now described. The filter 650 is housed within the attachment body 60. The filter 650 is configured to capture dust that has entered the attachment body 60 together with air so as to separate the dust from the air. The type of the filter 650 is not especially limited. For example, a synthetic resin (polymeric) open-cell foam, a HEPA filter (High Efficiency Particulate Air Filter), a powder filter, or a non-woven fabric filter may be employed. In this embodiment, the filter 650 is a powder filter having a mesh size that is smaller than those of the filters 41 and 42 of the blower 1. This is because while the filters 41 and 42 of the blower 1 are selected considering the efficiency of the blower 1 when the blower 1 is used alone as an air duster (a dust blower), the filter 650 of the dust collecting attachment 6 is selected considering its dust capturing performance.

As shown in FIGS. 7 to 9, in this embodiment, the filter 650 is a bellows-like folded filter having pleats 651. The filter 650 is housed within the attachment body 60 (the filter housing part 621) in a state in which the filter 650 is retained in a holder 653. The holder 653 has a cylindrical shape with a bottom. In other words, one axial end of the holder 653 is open and the other axial end of the holder 653 is closed by the bottom. The bottom of the holder 653 has ventilation holes. The filter 650 is fitted into the holder 653 such that the filter 650 is positioned in a circumferential direction of the holder 653 (such that the pleats 651 extend in a specified direction).

As shown in FIG. 9, two positioning protrusions 654 protrude radially outward from an end portion of the holder 653 at its open end. The two positioning protrusions 654 are diametrically opposite to each other. Similar to the exhaust part 63, two recesses are formed on an outer peripheral surface of the holder 653, and elastic pins 655 are fitted into the recesses, respectively. Further, a pressing frame 657 that prevents the filter 650 from dropping off from the holder 653 is fitted in the holder 653. In this manner, the filter 650, the holder 653, and the pressing frame 657 are integrated to form the filter unit 65 having a generally cylindrical shape.

The filter unit 65 is positioned relative to the attachment body 60 and is housed within the attachment body 60. More specifically, the filter unit 65 is fitted from the bottom side of the holder 653 into the filter housing part 621 that is formed by the first component 71 and the second component 72 integrated together as described above. Two ribs 725 protrude from an open end of a portion of the second component 72 that forms the filter housing part 621. One of the positioning protrusions 654 of the holder 653 is fitted between the two ribs 725 in the circumferential direction around the center axis of the filter housing part 621. Accordingly, the filter unit 65 is positioned relative to the attachment body 60 in the circumferential direction, and rotation of the filter unit 65 around the center axis relative to the attachment body 60 is restricted. Further, the elastic pins 655 are held in contact with the inner peripheral surface of the filter housing part 621 and causes the frictional resistance, so that rotation of the filter unit 65 relative to the attachment body 60 is restricted.

As shown in FIG. 8, in this embodiment, the filter unit 65 is positioned relative to the attachment body 60 in the circumferential direction such that the pleats 651 of the filter 650 extend generally in parallel to the extension direction of the inlet part 61.

Further, the third member 73 includes a flange part 731 formed at its axial end that is coupled to the first component 71 and the second component 72. When the third component 73 is coupled to the first component 71 and the second component 72 as described above, as shown in FIG. 7, the flange part 731 abuts the open end of the holder 653. This configuration thus restricts movement of the filter unit 65 relative to the attachment body 60 in an extension direction of a center axis of the filter unit 65.

The hose 68 is now described. As shown in FIGS. 4 and 5, the hose 68 is an elongate tubular member that is partially flexible. The hose 68 is removably coupled to the attachment body 60. More specifically, the hose 68 includes (i) a flexible part 680 having a bellows structure, (ii) a cylindrical first coupling part 681 that has a cylindrical shape and is coupled to one end of the flexible part 680, and (iii) a second coupling part 682 that has a cylindrical shape and is coupled to the other end of the flexible part 680.

The flexible part 680 of the hose 68 allows the user to easily change the orientation of the distal end of the hose 68 or the suction nozzle 69, relative to the attachment body 60. Further, the bellows structure of the flexible part 680 can suppress deformation of the sectional shape of the hose 68 when the hose 68 is bent. Such a structure can reduce a possibility that the air flow within the hose 68 is disrupted.

It is preferable that the hose 68 has a certain length such that the suction nozzle 69 can be placed at a desired position. For example, in a case in which the length of the hose 68 is more than 30 centimeters (cm), the user can easily direct a suction opening 690 of the suction nozzle 69 and the discharge opening 105 of the blower 1 toward the same direction. In this case, the user can easily operate the suction nozzle 69 while manipulating the trigger 181 of the blower 1, so that the operability (maneuverability) is enhanced. Further, it is preferable that the length of the hose 68 is at least about 80 cm, because the user can perform the dust collecting operation while holding the grip part 171 of the blower 1 with one hand and extending the other hand that holds the suction nozzle 69. It may be sufficient if the length of each of the first coupling part 681 and the second coupling part 682 of the hose 68 is, for example, approximately 10 cm. The remaining portion other than the first coupling part 681 and the second coupling part 682 may be formed as the flexible part 682. Further, various types of the hoses 68 having different lengths may be provided, so that any one of them is selectively coupled to the attachment body 60.

An outer diameter of a portion of the first coupling part 681 that is adjacent to the flexible part 680 is slightly larger than an inner diameter of the inlet part 61 of the attachment body 60. The first coupling part 681 is configured such that the diameter of the first coupling part 681 gradually and slightly decreases toward the distal end of the first coupling part 681. Thus, the user can removably couple the hose 68 to the attachment body 60 by fitting a portion of the first coupling part 681 into the inlet part 61. The second coupling part 682 has a generally uniform diameter.

The suction nozzle 69 is now described. As shown in FIGS. 4 and 5, the suction nozzle 69 is a tubular member. The suction nozzle 69 includes (i) a suction part 691 that has the suction opening 690 for sucking air, and (ii) a cylindrical coupling part 693 that is coupled to an end of the suction part 691 opposite to the suction opening 690. The coupling part 693 is configured to be removably coupled to the hose 68. An outer diameter of a portion of the coupling part 693 that is adjacent to the suction part 691 is slightly larger than an inner diameter of the second coupling part 682 of the hose 68. The coupling part 693 is configured such that the diameter of the coupling part 693 gradually and slightly decreases toward the distal end of the coupling part 693. Thus, the user can removably couple the suction nozzle 69 to the hose 68 by fitting a portion of the coupling part 693 into the second coupling part 682 of the hose 68. Alternatively, the user can removably couple the suction nozzle 69 to the attachment body 60 without the hose 68, by inserting the suction nozzle 69 into the inlet part 61 of the attachment body 60.

The suction nozzle 69 exemplarily described in this embodiment has a brush around the suction opening 690 of the suction part 691. However, the suction nozzle 69 is not limited to this example, and thus various types of suction nozzles may be provided for various usages.

As described above, the dust collecting system 9 of this embodiment includes the blower 1, and the dust collecting attachment 6 that is configured to be selectively attached to the blower 1. The dust collecting attachment 6 is used in a state in which the dust collecting attachment 6 is attached to the body housing 10 such that the second opening 602 of the attachment body 60 communicates with the inlet opening 101 of the body housing 10 of the blower 1. When the fan 35 is rotated by the motor 33 of the blower 1, air flows through the suction nozzle 69 and the hose 68 and then into the attachment body 60 through the first opening 601. The air that has flown into the attachment body 60 passes through the dust storage space 624, flows out through the second opening 602 to be sucked into the body housing 10. The dust in the air is accommodated in the dust storage space 624, which is defined between the first opening 601 and the second opening 602 within the attachment body 60, while the air passes the attachment body 60. Thus, a possibility that the dust enters the body housing 10 of the blower 1 and adversely affects the motor 33 can be reduced.

In particular, in this embodiment, since the filter 650 is disposed between the dust storage space 624 and the second opening 602, the dust is captured by the filter 650 and retained in the dust storage space 624. This configuration can reliably reduce the possibility that the dust enters the body housing 10 of the blower 1. Further, in this embodiment, the filter 650 is disposed such that the pleats 651 extend generally in parallel to the extension direction of the inlet part 61. This configuration can reduce a possibility that the dust is concentrated on a specific pleat or pleats 651 to cause clogging.

Further, the user can remove the filter 650 from the attachment body 60. More specifically, the user first removes the dust collecting attachment 6 from the blower 1. Thereafter, the user bends the flexible pieces 734 to disengage the protrusions 713 and 723 from the corresponding recesses 733, and removes the exhaust part 63 (the third member 73) from the housing part 62. The user then removes the filter unit 65 from the housing part 62. After the filter unit 65 is removed, the user can easily dispose of the dust that has accumulated in the dust storage space 624. Further, the user can clean or replace the filter 650, in order to suppress deterioration of the air-blowing efficiency, which may be caused by clogging of the filter 650.

Further, the user can open the lid 626 of the dust storage part 623 and remove the dust stored in the dust storage space 624 from the dust storage part 623 through the opening 625. Thus, if the filter 650 doe not need to be cleaned or replaced, the user can easily dispose of the dust without removing the attachment body 60 from the blower 1.

Correspondences between the components (features) of the above-described embodiment and the components (features) of the present disclosure or the present invention are as follows. However, the components of the embodiment are merely exemplary, and do not limit the components (features) of the present disclosure or the present invention.

The body housing 10 of the blower 1 is an example of a “housing of the blower”. The filter 650 of the dust collecting attachment 6 is an example of a “first filter of the dust collecting attachment”. The hose 68 is an example of a “tubular member”. Each of the filters 41 and 42 of the blower 1 is an example of a “second filter of the blower”. The inlet part 61 is an example of a “tubular part of the attachment body”.

The above-described embodiment is merely exemplary, and thus the dust collecting attachment and the dust collecting system according to the present disclosure are not limited to the dust collecting attachment 6 and the dust collecting system 9 of the above-described embodiment. For example, the following modifications may be made. Further, at least one of these modifications may be employed in combination with at least one of the dust collecting attachment 6 and the dust collecting system 9 of the above-described embodiment and the claimed features.

For example, the structures (e.g., the shapes, components and manner of coupling between the components) of the body housing 10 and the handle 17 of the blower 1 are not limited to those of the above-described embodiment and may be appropriately changed. For example, at least one of the shapes, sizes and positions of the inlet opening 101 and/or the discharge opening 105 may be appropriately changed. The structures and arrangements of the motor 33 and/or the fan 35 within the body housing 10 may be also appropriately changed. For example, the motor 33 may be a brushed motor or an AC motor. The fan 35 may be disposed between the motor 33 and the discharge opening 105. The number of the fans 35 may be two or more. For example, a plurality of the fans 35 may be disposed in multiple stages to be coaxial with the motor. The motor 33 and the fan 35 need not necessarily be housed in the case to form the motor assembly 30 as described in the above-described embodiment. For example, the motor shaft 335 may be rotatably supported by bearings that are supported by the body housing 10.

The attachment structure (the coupling or connecting structure) of the dust collecting attachment 6 (the attachment body 60) to the blower 1 is not limited to the structures of the rear end portion 15 of the blower 1 and the exhaust part 63 of the dust collecting attachment 6 of the above-described embodiment. For example, the body housing 10 (the rear end portion 15) of the blower 1 and the attachment body 60 (the exhaust part 63) may be removably coupled to each other by a threaded engagement or snap-fit. Also, the attachment body 60 may be removably coupled to the body housing 10 of the blower 1 using separate screws.

The attachment body 60 of the dust collecting attachment 6 may be appropriately changed as long as the attachment body 60 has the first opening 601 (the inlet opening), the second opening 602 (the exhaust opening), and the dust storage space 624 formed between the first opening 601 and the second opening 602. For example, the attachment body 60 may have a shape different from that in the above-described embodiment. For example, the attachment body 60 may have a structure that is suitable to perform the dust collecting operation by itself (i.e., without the hose 68 and the suction nozzle 69). Specifically, the inlet part 61 may have a shape like a nozzle that is suitable to suck dust and the first opening 601 may serve as a suction opening as it is. Further, the attachment body 60 may be formed by a plurality of components that are different from those in the above-described embodiment. The material of the components may also be appropriately changed. The manner of connection between the components is not limited to the snap-fit, and may be changed to any known manner.

The orientation of the pleats 651 of the filter 650 relative to the attachment body 60 and the structure for retaining the filter 650 may be appropriately changed. For example, the filter 650 may be fixed to the attachment body 60. Specifically, the holder 653 of the above-described embodiment shown in FIG. 5 may be integrated with the attachment body 60 as an integral (inseparable) portion of the attachment body 60. Further, the filter 650 may be fixed to the holder 653 to be substantially irremovable from the holder 653. In this modification, the user can remove the dust collecting attachment 6 from the blower 1 and clean the filter 650. Further, it is preferable that the filter 650 of the dust collecting attachment 6 has a smaller mesh size than the filters 41 and 42 of the blower 1. The filter 650 may, however, have substantially the same mesh size as at least one of the filters 41 and 42. Further, the mesh sizes of the filters 41 and 42 of the blower 1 may be substantially identical to each other. At least one of the filters 41 and 42 may be omitted.

An entirety, not a portion, of the hose 68 may have a spiral bellows structure. In this modification, spiral grooves (screw grooves) that are complementary to the spiral bellows structure of the hose 68 may be formed on the inner peripheral surface of the inlet part 61 of the attachment body 60 and the inner peripheral surface of the coupling part 693 of the suction nozzle 69. Thus, the hose 68 and the attachment body 60, and the hose 68 and the suction nozzle 69 can be removably coupled to each other by threaded engagements. The hose 68 may be irremovable from the attachment body 60. Similarly, the suction nozzle 69 may be irremovable from the hose 68.

Further, in view of the nature of the present invention, the above-described embodiment and the modifications thereof, the following Aspects are provided. Any one or more of the following Aspects can be employed in combination with any one or more of the above-described embodiment, the modifications thereof, and the claimed features.

### (Aspect 1)

The attachment body has a first coupling part that is configured to be coupled to the housing of the blower.

The exhaust part 63 is an example of the “first coupling part’ in this aspect.

### (Aspect 2)

The first coupling part is configured such that the first coupling part can be coupled to the housing without using a separate jig or tool for the coupling.

### (Aspect 3)

The attachment body includes (i) a tubular inlet part that has the first opening, (ii) a tubular exhaust part that has the second opening, and (iii) a housing part that is coupled to the inlet part and the exhaust part, and the dust storage space is defined within the housing part.

### (Aspect 4)

The exhaust part is configured as a first coupling part that is configured to be removably coupled to the housing of the blower.

### (Aspect 5)

The first filter is housed within the housing part.

### (Aspect 6)

The exhaust part is removably coupled to the housing part.

### (Aspect 7)

The filter is a bellows-like filter having pleats, and the filter is disposed such that the pleats are generally in parallel to an extension direction of the tubular part (or the inlet part).

### (Aspect 8)

The tubular member is removably coupled to the attachment body.

### (Aspect 9)

The dust collecting attachment further includes a suction nozzle that is coupled to the tubular member.

### (Aspect 10)

The inlet opening, the exhaust opening, the motor, and the fan of the blower are coaxially arranged.

### DESCRIPTION OF THE REFERENCE NUMERALS

1: blower, 10: body housing, 101: inlet opening, 105: discharge opening, 11: nozzle part, 13: housing part, 15: rear end portion, 150: engagement groove, 151: first portion, 152: second portion, 153: wall portion, 16: inlet-side cover, 160: opening, 17: handle, 171: grip part, 175: controller-housing part, 176: battery mounting part, 181: trigger, 182: switch, 19: battery, 30: motor assembly, 33: motor, 331: stator, 335: motor shaft, 35: fan, 37: controller, 41: filter, 42: filter, 6: dust collecting attachment, 60: attachment body, 600: passage, 601: first opening, 602: second opening, 61: inlet part, 615: shoulder part, 62: housing part, 621: filter housing part, 623: dust storage part, 624: dust storage space, 625: opening, 626: lid, 63: exhaust part, 631: end portion, 632: engagement protrusion, 633: recess, 634: elastic pin, 64: check valve, 641: protrusion, 642: screw, 65: filter unit, 650: filter, 651: pleat, 653: holder, 654: positioning protrusion, 655: elastic pin, 657: pressing frame, 68: hose, 680: flexible part, 681: first coupling part, 682: second coupling part, 69: suction nozzle, 690: suction opening, 691: suction part, 693: coupling part, 71: first component, 711: protrusion, 713: protrusion, 72: second component, 721: recess, 723: protrusion, 725: rib, 73: third component, 731: flange part, 733: recess, 734: flexible piece, 9: dust collecting system

What is claimed is:

1. A dust collecting attachment that is configured to be removably attached to a blower including (i) a housing that has an inlet opening and a discharge opening, (ii) a motor that is within the housing, and (iii) a fan that is within the housing and is configured to be rotated by the motor to generate a flow of air that is sucked into the housing through the inlet opening and is discharged from the discharge opening via the motor, the dust collecting attachment comprising:
an attachment body that has (i) a first opening, (ii) a second opening, and (iii) a dust storage space between the first opening and the second opening,
wherein the attachment body is configured to be attached to the housing such that the second opening communicates with the inlet opening of the housing of the blower.

2. The dust collecting attachment as defined in claim 1, further comprising:
a first filter that is housed within the attachment body between the dust storage space and the second opening.

3. The dust collecting attachment as defined in claim 2, wherein the first filter is removable from the attachment body.

4. The dust collecting attachment as defined in claim 2, wherein the first filter is fixed to the attachment body.

5. The dust collecting attachment as defined in claim 1, wherein the attachment body includes a check valve between the first opening and the dust storage space.

6. The dust collecting attachment as defined in claim 1, wherein the attachment body has (i) an opening that communicates with the dust storage space and an outside, and (ii) a lid that is configured to open and close the opening.

7. The dust collecting attachment as defined in claim 1, further comprising:
an elongate tubular member that is coupled to the first opening of the attachment body,
wherein at least a portion of the tubular member is flexible.

8. The dust collecting attachment as defined in claim 1, wherein the attachment body is configured to define a passage that is bent or curved in a generally L-shape.

9. The dust collecting attachment as defined in claim 8, wherein:
the attachment body includes (i) a first tubular part that has the first opening, (ii) a second tubular part that has the second opening, and (iii) a housing part that (a) is coupled to the first tubular part and the second tubular part and (b) defines the dust housing space.

10. The dust collecting attachment as defined in claim 9, further comprising:
a first filter that is housed within the attachment body between the dust storage space and the second opening.

11. The dust collecting attachment as defined in claim 10, wherein the attachment body includes a check valve between the first opening and the dust storage space.

12. The dust collecting attachment as defined in claim 11, wherein the attachment body has (i) an opening that communicates with the dust storage space and an outside, and (ii) a lid that is configured to open and close the opening.

13. A dust collecting system comprising:
a blower; and
a dust collecting attachment,
wherein:
the blower comprises (i) a housing that has an inlet opening and a discharge opening, (ii) a motor that is within the housing, and (iii) a fan that is within the housing and is configured to be rotated by the motor to generate a flow of air that is sucked into the housing through the inlet opening and is discharged from the discharge opening via the motor;
the dust collecting attachment comprises an attachment body that has (i) a first opening, (ii) a second opening, and (iii) a dust storage space between the first opening and the second opening, and
the attachment body is removably attached to the housing of the blower such that the second opening of the attachment body communicates with the inlet opening of the housing of the blower.

14. The dust collecting system as defined in claim 13, wherein:
the dust collecting attachment further comprises a first filter that is housed within the attachment body between the dust storage space and the second opening, and
the first filter faces the inlet opening of the housing of the blower.

15. The dust collecting system as defined in claim 14, wherein:
the blower further comprises a second filter between the inlet opening and the motor, and
the first filter of the dust collecting attachment has a mesh size that is smaller than a mesh size of the second filter of the blower.

16. The dust collecting system as defined in claim 13, wherein:
the attachment body includes a first tubular part that has the first opening at its distal end,
the first tubular part is configured to extend in a direction that crosses a rotational axis of the motor when the attachment body is attached to the housing of the blower, and
the housing of the blower and the attachment body are configured such that a position of the first tubular part is changeable in a circumferential direction around the rotational axis.
